(19) United States
(12) Patent Application Publication
(10) Pub. No.: US 2012/0276304 A1
(43) Pub. Date: Nov. 1, 2012

(54) METHOD FOR REPAIRING A TITANIUM BLADE BY LASER RECHARGING AND MODERATE HIP PRESSING

(75) Inventor: Gérard Derrien, Houilles (FR)

(73) Assignee: SNECMA, Paris (FR)

(21) Appl. No.: 13/512,054

(22) PCT Filed: Dec. 8, 2010
(86) PCT No.: PCT/EP10/69220

§ 371 Date: May 25, 2012

(30) Foreign Application Priority Data
Dec. 14, 2009 (FR) 0958956

(51) Int. Cl. B05D 7/14; B05D 3/12; B05D 3/06

(52) U.S. Cl. 427/554

(57) ABSTRACT

A method for repairing a metal part by recharging damaged parts by spraying a powder of metal onto the metal part, wherein the process includes laser recharging the damaged parts using the powder, followed by hot isostatic compression, the maximum temperature applied during the isostatic compression not exceeding the recrystallization temperature of the metal.

The field of the present invention is that of aeronautical turbine engines, and in particular that of repairing the compressor blades of these turbine engines.

Aeronautical turbine engines typically comprise one or more compressors placed in series, in which the air is compressed before being injected into a combustion chamber. In the latter, the air is mixed with a fuel then burnt. The combustion gases pass through one or more turbine stages, which extract the power necessary for driving the compressor or compressors, then they are exhausted through a nozzle to produce the desired thrust. In modern civil turbofan engines with a high bypass ratio, an additional compression stage called a fan is placed upstream of the first compressor (low-pressure compressor). The blades of such a fan have large dimensions and are exposed to agressions due to the airstream, such as atmospheric perturbations, dust or foreign bodies which might be taken in by the engine.

Because of the erosion caused by these agressions, the fan blades more or less rapidly exhibit wear which needs to be overcome, either by trying to increase the lifetime permitted for damaged blades or by conceiving rectification solutions for these blades.

Several solutions have been proposed for refilling the leading edge, or some other part of the compressor blades, after they have been eroded during use. For instance, International Patent Application WO 2007/027177 filed by the company Honeywell proposes a method for refilling fan blades made of titanium alloy by a method called cold gas dynamic spraying. This method relates to the spraying of a metal powder, the particles of which aggregate on the blade owing to their kinetic energy and thus form a layer which can restore the blade to its initial profile. This method has the drawback of leaving significant pores existing in the sprayed layer. In order to resolve this problem, the method described in the patent application provides for a hot isostatic pressing (HIP) operation to be carried out under relatively severe conditions, since it is necessary to subject the part being repaired to a pressure of from 700 to 1000 bar and a temperature of from 1400 to 1500° C. for one hour, then maintain it at a temperature of the order of 900° C. for several hours.

The drawback associated with such a temperature rise of the part is that the titanium loses much of its rigidity and the blade then has a tendency to deform. Furthermore, the employed technique of spraying a metal in powder form using a cold gas does not permit refilling with sufficiently precise positioning. This technique therefore has to be supplemented by machining which restores the blade to its precise geometrical shape.

Another solution which may be envisaged is laser refilling, which makes it possible to obtain more precise dimensions and thus allows the final machining operations to be obviated, or at least reduced to simple adjustment operations which are carried out manually. Laser refilling is a technique of refilling by welding, which consists in depositing a layer of metal on the surface of the part. The filler metal is supplied in the form of a wire or a powder using an inert gas, then is injected laterally or coaxially into the laser beam. With this system, some of the energy delivered by the laser beam is used to preheat the powder in the beam, while an energy fraction transmitted through the powder jet makes it possible to remelt the surface of the substrate superficially. The molten pool is sustained by the supply of energy by the laser.

This solution makes it possible to refurbish a blade directly to its final dimensions, but it does not fully eliminate the problems associated with insufficient compactness. Even though, with suitable adjustment of the laser, the pores observed are much less significant than in the previous case, it is still necessary to resort to a method of eliminating them after the refilling, in order to ensure a sufficient fatigue strength in the case of titanium alloy compressor blades.

Other methods of refilling by spraying metal, followed by compaction operations such as HIP pressing, have been proposed, for example those described in the Patent Applications EP 1643011 and EP 1743729 of the company General Electric, or EP 1897972 of United Technologies. It will be noted that these hot isostatic pressing operations are carried out under high-temperature conditions, since they generally exceed the temperature of 700° which, for the titanium alloy TA6V, corresponds to its recrystallization temperature. In the first document D1, the temperature used lies between “substantially 700°” and “substantially 950°”, while in the third it ranges from 800 to 1000°; it is not specified in the second document.

Likewise, the pressures applied during these HIP pressing operations (varying between 14 and 28 bar for the first, and of the order of 10 bar for the third) generally remain relatively low in this case, which is not very favorable for the elimination of pores. It is an object of the present invention to overcome these drawbacks by providing a repair method which does not have at least some of the drawbacks of the prior art and, in particular, which eliminates the possible pores created during the refilling, without the risk of deforming the profile of the blade.

To this end, the invention relates to a method for repairing a metal part by refilling the damaged parts by spraying a powder of said metal onto said part, characterized in that the method comprises a step of laser-refilling the damaged parts with the aid of said powder, followed by a step of hot isostatic pressing, the maximum temperature applied during said isostatic pressing not exceeding the recrystallization temperature of said metal.

By remaining below the recrystallization temperature of the metal, deformations of the metal part are avoided and it can be produced to final dimensions during the laser refilling operation. No milling operation is then necessary after the HIP pressing in order to restore the part to its precise geometrical shape.

Preferably, this method may be carried out on a turbine engine compressor blade made of titanium alloy.

In this case, the maximum temperature is at most equal to 680° C.

In one particular embodiment, the part is maintained at the maximum temperature for a time at least equal to two 2 hours.

The increase in the holding time at the maximum temperature makes it possible to compensate for the lowering of said maximum temperature and obtain a similar result.

Preferably, the pressure of the isostatic pressing is at least equal to 970 bar.

In a particular embodiment, the temperature rise does not exceed 350° C./h.

In another particular embodiment, the temperature decrease at the end of isostatic pressing does not exceed 100° C./h.

Advantageously, the pressure decrease at the end of isostatic pressing does not exceed 20 bar/min.

The invention will be better understood, and other objects, details, characteristics and advantages thereof will appear more clearly during the following detailed explanatory description of an embodiment of the invention given by way of purely illustrative and nonlimiting example, with reference to the appended schematic drawing.

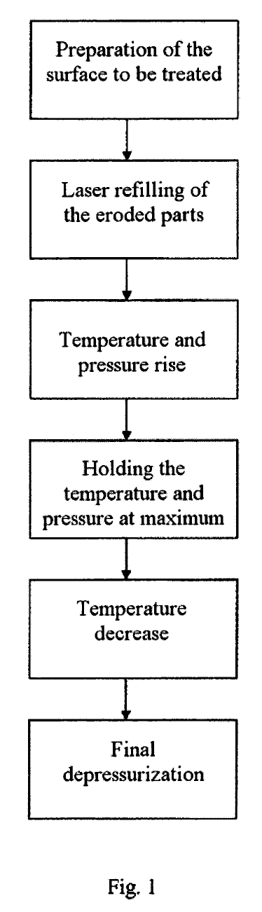

FIG. 1 is a sequential view of the implementation steps of a method for repairing titanium alloy blades according to an embodiment of the invention.

The method according to the invention is carried out in the following way:

The surface of the part to be repaired is first prepared in an entirely conventional way, by using a method known to the person skilled in the art.

It is then arranged in a laser refilling apparatus in which the eroded parts are reconstructed. This refilling is carried out without applying a masking template, since the method is sufficiently precise to add metal at the deficient locations without extending beyond the zone to be refilled.

The part obtained in this way still comprises pores which have a small size (between 10 and 40 microns) but which are still sufficient to initiate starting points of fatigue cracks, and which therefore prevent the blade from being provided with a remaining lifetime equal to that which it had before the refilling. This is why it is necessary to supplement this refilling with a densification operation.

As seen above, a conventional operation of densification by hot isostatic pressing, under the thermal conditions conventionally used, would lead to deformations of the geometry of the blade making it unfit for reuse.

The invention proposes to carry out a hot isostatic pressing operation under temperature conditions lower than those of the HIP methods conventionally employed. By means of an increase in the holding time at this temperature, a similar result is then obtained in terms of densification.

In the case of a blade made of titanium alloy such as TA6V, the part is first heated to a temperature at most equal to 700° C. in a neutral atmosphere such as argon, for a time of about 2 hours. Simultaneously, the pressure of the chamber containing the part is raised to 1000 bar +/−30 bar. The preferred temperature for carrying out this HIP pressing is 665° C., with a tolerance of plus or minus 15°.

The part is maintained under these conditions for a time of about 2 hours.

After this holding at at most 700° C., the temperature of the chamber is progressively reduced to 400° C. over an additional time of about 2 hours 30 minutes.

Lastly, the pressure is reduced to the atmospheric value according to a decrease law which remains constantly less than a rate of 20 bar/min.

Preferably, the temperature rise is carried out with a gradient of 350° C. per hour and the decrease with a gradient of 100° C./h.

The results obtained after carrying out this method on a fan blade have shown, before and after densification:
by photogrammetry on the part, that the geometry of the blade was unchanged,
by tomography on specimens which had undergone the same method, that the pores had disappeared, or at least had become of a size undetectable with the aid of the means used.

Mechanical characterization tests have confirmed that the refilled blade behaves as a non-refilled blade, and therefore that it is possible to provide it with a remaining lifetime identical to that which it would have had without repair.

It will be noted that the maximum temperature used during the HIP pressing lies below 700° C., that is to say below the recrystallization temperature of the titanium alloy TA6V, which is used for the annealing operations. The invention consequently claims the densification operations for metallic materials which are carried out by hot isostatic pressing performed at a temperature lower than the recrystallization temperature of the material in question.

1-8. (canceled)

9. A method for repairing a metal part by refilling damaged parts by spraying a powder of the metal onto the metal part, the method comprising:
laser-refilling the damaged parts with aid of the powder; and
then hot isostatic pressing, a maximum temperature applied during the isostatic pressing not exceeding recrystallization temperature of the metal.

10. The method as claimed in claim 9, wherein the part is a turbine engine compressor blade made of titanium alloy.

11. The method as claimed in claim 10, wherein the maximum temperature is at most equal to 680° C.

12. The method as claimed in claim 9, wherein the metal part is maintained at the maximum temperature for a time at least equal two 2 hours.

13. The method as claimed in claim 9, wherein pressure of the isostatic pressing is at least equal to 970 bar.

14. The method as claimed in claim 9, wherein a temperature rise does not exceed 350° C./h.

15. The method as claimed in claim 9, wherein a temperature decrease at an end of isostatic pressing does not exceed 100° C./h.

16. The method as claimed in claim 9, wherein a pressure decrease at an end of isostatic pressing does not exceed 20 bar/min.
